(19) United States
(12) Patent Application Publication
(10) Pub. No.: US 2004/0114773 A1
(43) Pub. Date: Jun. 17, 2004

(54) Assembly for making an electrical connection between components

(76) Inventors: James M. Jensen, Columbia, MD (US); Jack C. Crystal, Owings Mill, MD (US)

Correspondence Address: ST. ONGE STEWARD JOHNSTON & REENS, LLC, 986 BEDFORD STREET, STAMFORD, CT, 06905-5619, US

(21) Appl. No.: 10/320,879

(22) Filed: Dec. 17, 2002

(51) Int. Cl. H04R 1/02; H04R 3/00

(52) U.S. Cl. 381/111; 381/122; 381/91

(57) ABSTRACT

An audience data gathering device includes a microphone, a circuit board and a processor mounted in an enclosure. A compliant body is pressed against the microphone and the circuit board to couple the microphone to the processor through the circuit board. An assembly for making an electrically conductive connection between two components includes a compliant body pressing against the two components and having an electrical conductor extending on a circumferential surface of the complaint body so that the conductor is held against electric terminals on each of the components.

### FIELD OF THE INVENTION

The invention relates to an assembly for making an electrically conductive connection between components and to audience data gathering devices incorporating such an assembly.

### BACKGROUND OF THE INVENTION

In order to make an electrical connection between two components of an electrical device, for example an audience data gathering device, electric terminals of the two components are typically connected via conductive wires by soldering, pressure or other known connection methods. Such conventional connection methods require elaborate skills for the assembly and involve labor intensive processes, thus increasing manufacturing cost of these products.

Typical component mounting and connecting techniques also create a rigid structure in which vibrational energy is readily coupled from one component to another. However, certain electrical components, such as microphones, are sensitive to vibrational energy so that it interferes with correct operation of the component. In the case of a microphone, stray vibrational energy increases the noise level in the microphone's output signal.

While components sensitive to vibrational energy can be mounted in energy-absorbent assemblies, their terminals are still rigidly coupled with wire leads to connect them to circuitry. Vibration can, over the long term, degrade such rigid connections leading to their failure.

For this application the following terms and definitions shall apply, both for the singular and plural forms of nouns and for all verb tenses:

The term “data” as used herein means any indicia, signals, marks, domains, symbols, symbol sets, representations, and any other physical form or forms representing information, whether permanent or temporary, whether visible, audible, acoustic, electric, magnetic, electromagnetic, or otherwise manifested. The term “data” as used to represent certain information in one physical form shall be deemed to encompass any and all representations of the same information in a different physical form or forms.

The term “audio data” as used herein means any data representing acoustic energy, including, but not limited to, audible sounds, regardless of the presence of any other data, or lack thereof, which accompanies, is appended to, is superimposed on, or is otherwise transmitted or able to be transmitted with the audio data.

The terms “audience” and “audience member” as used herein mean a person or persons, as the case may be, who access media data in any manner, whether alone or in one or more groups, whether in the same or various places, and whether at the same time or at various different times.

The term “processor” as used herein means data processing devices, apparatus, programs, circuits, systems, and subsystems, whether implemented in hardware, software, or both and whether used to process data in analog or digital form.

The terms “communicate” and “communicating” as used herein include both conveying data from a source to a destination, as well as delivering data to a communications medium, system or link to be conveyed to a destination. The term “communication” as used herein means the act of communicating or the data communicated, as appropriate.

The terms “coupled”, “coupled to”, and “coupled with” as used herein means a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, or (c) a functional relationship in which the operation of any one or more of the relevant devices, apparatus, files, programs, media, components, networks, systems, subsystems, or means depends, in whole or in part, on the operation of any one or more others thereof.

The term “media data” as used herein means data which is widely accessible, whether over-the-air, or via cable, satellite, network, internetwork (including the Internet), distributed on storage media, or otherwise, without regard to the form or content thereof, and including but not limited to audio, video, text, images, animations, web pages and streaming media data.

It is noted that the present invention is particularly useful in isolating the components of an electric device of any kind from noise and other undesirable effects while maintaining stable electrical connections between such components. More particularly, the invention is useful to isolate acoustic energy resulting from relative movements or vibrations of a microphone with respect to adjoining components, for example an input terminal of a data processor of an audience data gathering device. Such vibrations or relative movements of the microphone with respect to the adjoining components electrically connected thereto can generate noise in the output signal from the microphone which is harmful to the performance of the device, such as an audience data gathering device.

In accordance with one aspect of the present invention, an audience data gathering device is provided, which comprises an enclosure having a sound port; a microphone mounted in the enclosure and communicating acoustically with an exterior of the enclosure through the sound port to receive acoustic energy therefrom and serving to transduce the acoustic energy to electrical data; a processor mounted in the enclosure and having an input; a circuit board mounted in the enclosure and having an electrical conductor thereon coupled with the input of the processor; the microphone having an electrical output terminal thereon; a compliant body having a circumferential surface pressing against the electrical output terminal of the microphone and the circuit board; and an electrical conductor extending on the circumferential surface of the compliant body and pressed thereby against and in electrical contact with the output terminal of the microphone and the electrical conductor of the circuit board.

In accordance with another aspect of the present invention, an assembly for making an electrically conductive connection between two components is provided, which comprises a first electrical component having a first electrical terminal on an exterior surface thereof; a second electrical component having a second electrical terminal on an exterior surface thereof; a compliant body having a curved circumferential surface pressing against the exterior surfaces of the first electrical component and the second electrical component; and an electrical conductor extending on the circumferential surface of the compliant body and pressed against the first electrical terminal and the second electrical terminal between the compliant body and the first and second electrical components, such that the first and second electrical terminals of the first and second electrical components are electrically connected by the electrical conductor.

The invention and its particular features and advantages will become more apparent from the following detailed description considered with reference to the accompanying drawings.

### BRIEF DESCRIPTION OF THE DRAWINGS

FIG. 1 is a perspective view of an embodiment of an audience data gathering device according to the present invention.

FIG. 2 is a block diagram illustrating the operation of the audience data gathering device of the FIG. 1 embodiment.

FIG. 3 is a schematic cross-sectional view illustrating a portion of the audience data gathering device of the FIG. 1 embodiment.

FIG. 3A is a perspective view illustrating a compliant body incorporated in the FIG. 1 embodiment with electrical conductors extending on the circumferential surface of the compliant body.

FIG. 4 is a perspective view of a housing for use in mounting a microphone to a circuit board of an audience data gathering device.

FIG. 4A is a cross-sectional view taken along the lines 4A-4A in FIG. 4.

FIG. 4B is a cross-sectional view taken along the lines 4B-4B in FIG. 4.

FIG. 4C is a cross-sectional view taken along the lines 4C-4C in FIG. 4A.

### DETAILED DESCRIPTION OF CERTAIN ADVANTAGEOUS EMBODIMENTS

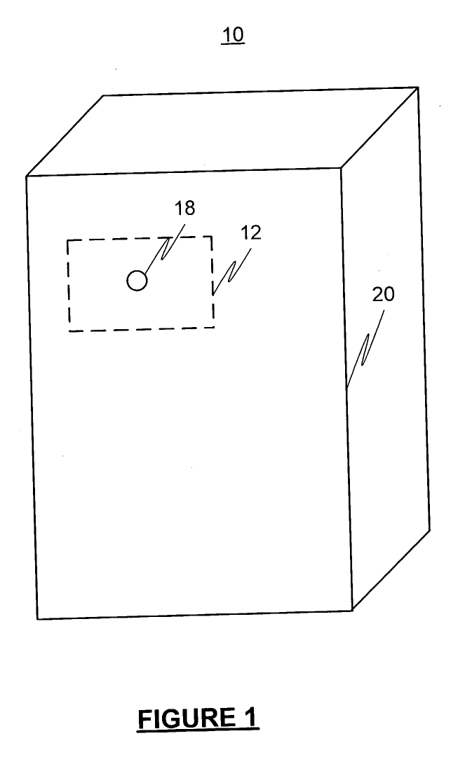

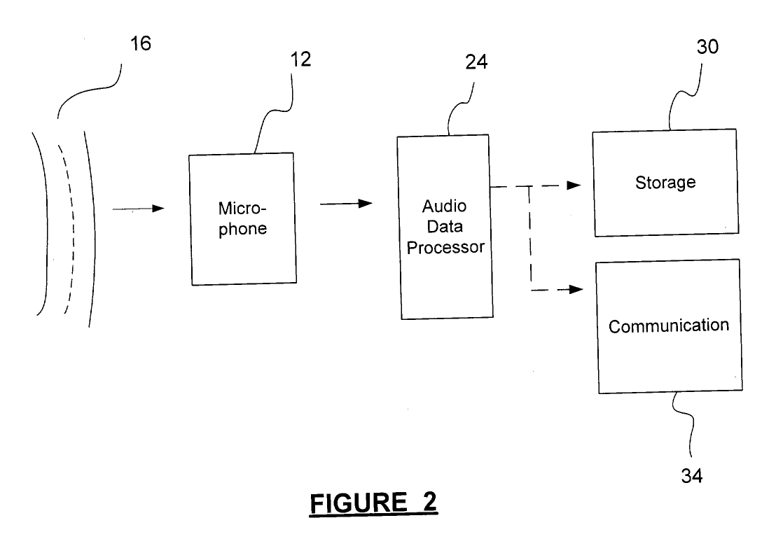

FIG. 1 is a perspective view of an audience data gathering device 10 which monitors acoustic energy in the vicinity of one or more audience members by means of a microphone 12 and processes electrical data provided at an output of the microphone to produce audience exposure data representing media data to which the audience member or members have been exposed. With reference also to FIG. 2, the microphone 12 receives acoustic energy 16 through a sound port 18 provided in a case 20 of the device 10. The microphone 12 transduces the received acoustic energy 16 to electrical data which it provides to an audio data processor 24 through electrical conductors, as explained herein below.

The processor 24 in certain embodiments processes the electrical data to produce processed data in the form of ancillary codes identifying or characterizing media data included in the acoustic energy received by the microphone 12. In certain other embodiments, the processor 24 extracts signatures from the electrical data as processed data for use in a matching process with previously stored signatures to identify or characterize media data included in the acoustic energy. In still other embodiments, the processor 24 carries out preliminary processing of the electrical data to filter, transform and/or compress the same to produce processed data for communication to another processor or facility where ancillary codes and/or signatures are extracted therefrom. In certain embodiments, the processor 24 serves to communicate the electrical data in the same or a different form to a further processor or facility for further processing.

The processed data from the processor 24 in certain embodiments is stored by a storage unit 30 to be communicated subsequently to a further processor or facility by means of a communication unit 34. In other embodiments, the processed data from the processor 24 is communicated by unit 34 without prior storage.

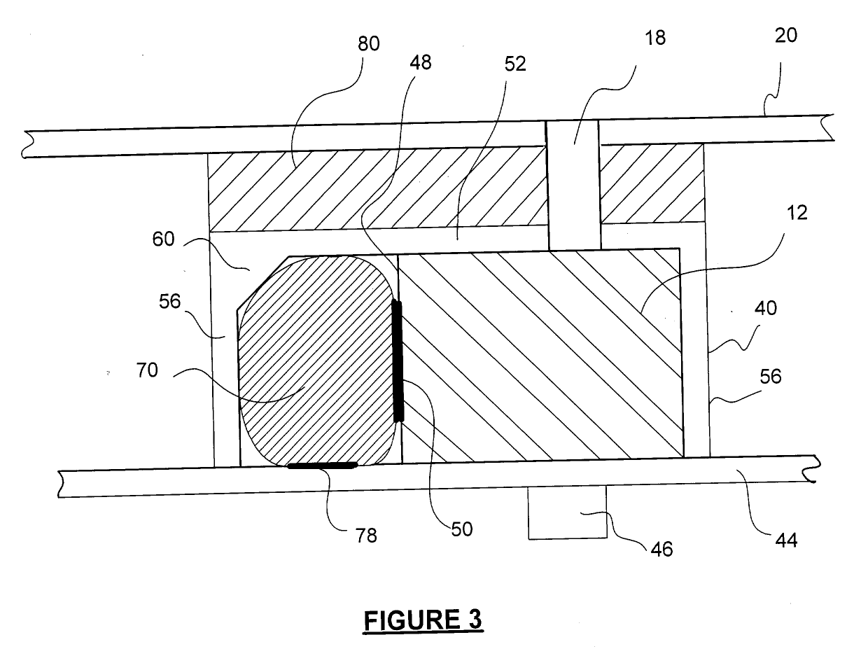

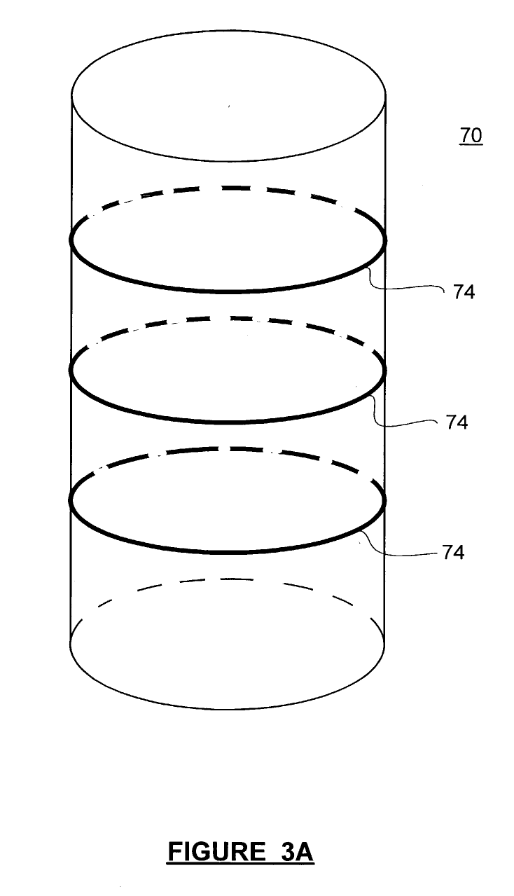

Referring to FIG. 3, the microphone 12 is retained by a housing 40 affixed to a circuit board 44 by a hold-down clip 46, and is coupled electrically to the processor 24 through the circuit board 44. In certain embodiments, the processor comprises one or more components (not shown for simplicity and clarity) mounted on the circuit board 44. In certain other embodiments, the processor comprises one or more components mounted elsewhere in the case 20 but coupled to the microphone 12 through the circuit board 44.

The microphone 12 has a generally box-like outer configuration including a plurality of outer walls, such as a first wall 48 having electrical output terminals 50 thereon. The microphone 12 may be, for example, a Knowles® EK Series Microphone. In the embodiment shown in FIG. 3, the output terminals 50 include three conductor portions spaced apart from one another for providing electrical coupling between the microphone 12 and the processor 24 through the circuit board 44. The conductor portions are arranged on the first wall 48 with parallel relation to one another. However, the number, patterns and orientation of the conductor portions may be varied depending upon the design of the microphone. The housing 40 includes a top wall portion 52 and side wall portions 56 made of a suitable material, for example, high durometer silicone rubber, etc. The housing 40 also includes a wedge portion 60 at an upper corner of the housing facing the first wall 48 of the microphone 12 and the circuit board 44.

A compliant body 70 is introduced within a cavity defined between the wall portions of the housing 40 and wedge 60 of the housing 40 and the first wall 48 of the microphone 12. The compliant body 70 is preferably made of silicone rubber and has a bar-like configuration with a general circular, oval or rectangular cross-sectional area. The compliant body 70 may be made from any suitable non-conductive material. As shown in FIG. 3A, the compliant body 70 includes one or more electrical conductors 74 disposed on a circumferential surface of the compliant body 70. The electrical conductors 74 may have various configurations, for example with a ring-like configuration as shown in FIG. 3A. The electrical conductors 74 are made of metal (such as gold) or other suitable electrically conductive material, and are arranged to contact the output terminals 50 of the microphone 12 when the compliant body 70 is disposed as shown in FIG. 3. In certain embodiments, the conductors 74 are embedded in a groove provided on the circumference of the compliant body. In other embodiments the conductors 74 are conductive coatings deposited on the compliant body 70.

Upon insertion of the compliant body 70 into position within the cavity in the housing 40, the compliant body 70 is compressed to a certain degree and has a tendency to expand. Thus, it continuously presses the microphone 12 and circuit board 44 which has corresponding conductors 78 thereon. The conductors 74 are positioned on the surface of the compliant body so that they are each aligned with and are pressed against a respective one of the output terminals 50 of the microphone 12 and the conductors 78 of the circuit board 44, thus to make an electrical connection between each of the output terminals 50 and its respective one of the conductors 78 on the circuit board 44. Thereby, the microphone 12 is electrically connected to the conductors 78 of the circuit board 44 through the conductors 74 of the compliant body 70.

As mentioned, conductors 78 of the circuit board 44 are coupled with the input terminal of the processor 24 to produce processed data. This electrical connection via the compliant body 70 is substantially stable and secure because the compliant body 70 always presses against the microphone 12 and circuit board 44 thereby maintaining an electrical connection therebetween despite vibration and other motion of the microphone 12 relative to the circuit board 44. The wedge portion 60 of the housing 40 assists in maintaining the secure connection by pressing the compliant body toward both the circuit board 44 and the microphone 12. This arrangement also provides noise resistance since such continuous pressure by the compliant body 70 maintains the stable connections even in the event of vibrations or sudden impact of the device 10 often occurring during use. For further facilitating noise resistance, the housing 40 may optionally include compliant material 80 disposed between the top wall 52 of the housing 40 and the case 20. The compliant material 80 seals the microphone 12 and absorbs vibrations or impacts through the case 20. Such compliant material may be disposed around the microphone 12 for further securing the device against vibrations through the housing and the circuit board 44. The case 20, compliant material 80 and top wall 52 of the housing 40, in combination, define sound port 18 (see also in FIG. 1) at a suitable location for transmitting acoustic energy 16 therethrough to the microphone 12.

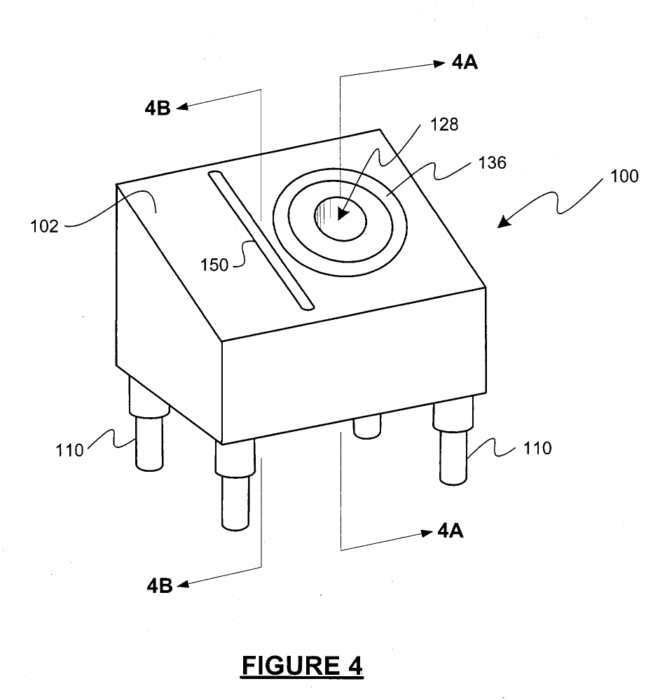

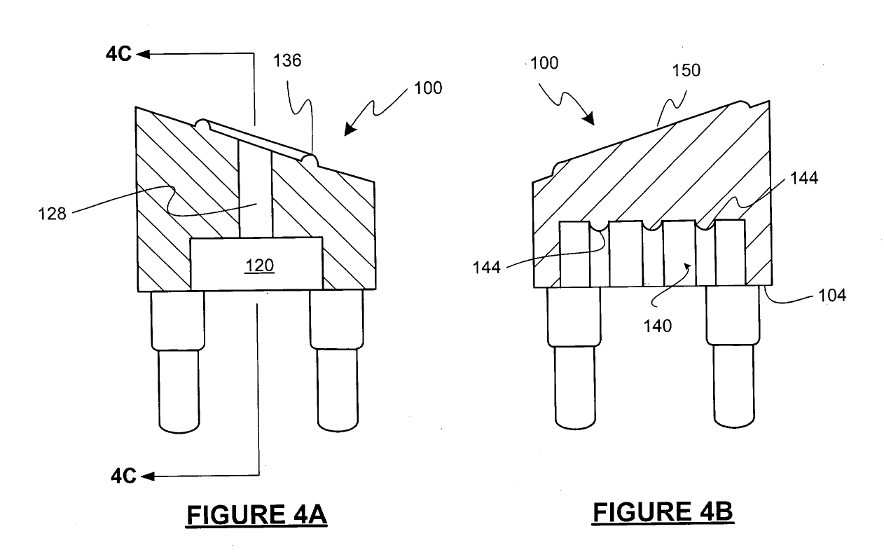

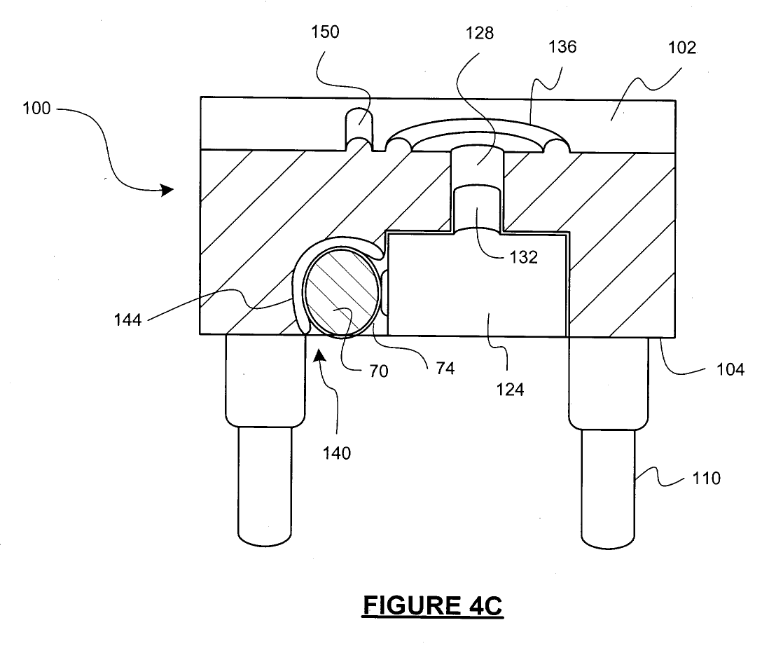

FIG. 4 illustrates a further embodiment of a housing 100 for mounting a microphone to a circuit board device such as an audience data-gathering device. The housing 100 is made of an insulating and slightly compliant material, such as high durometer silicone rubber, and has a lower surface 104 and an upper surface 102 arranged in parallel relation to a case of the device (not shown for purposes of simplicity and clarity) when it is assembled. The housing also includes four legs 110 for fixing the housing 100 to the circuit board. Housing 110 preferably is molded as a single piece.

With reference to FIG. 4A, the housing 100 is formed with a first inner cavity 128 shaped to conform to and retain a microphone 124, illustrated in FIG. 4C, and a microphone port 128 extending from the cavity 120 through the surface 102. The port 128 receives an acoustic input 132 of a microphone 124 as shown in FIG. 4C to conduct acoustic energy thereto from a corresponding opening in the case. It will also be seen from FIG. 4C that the acoustic input 132 is spaced from the surface 102 thus to reduce the likelihood of electrostatic discharge between the case in the acoustic input 132.

An annular rib 136 is formed on the surface 102 surrounding and spaced from the port 128 on the surface 102. When the device is assembled, the rib 136 is pressed against the casing to provide an acoustic and fluid sealed thereagainst, as well as to absorb the energy of impacts to and vibrations of the case.

The housing 100 is also provided with the second inner cavity 140 shaped to receive the curved outer surface of the compliant body 70 and urge it laterally against one or more output terminals 142 of a microphone 124 and downwardly against corresponding conductors on the circuit board (not shown for purposes of simplicity and clarity). The cavity 140 is provided with one or more inwardly extending ribs 144 arranged on the surface of the cavity 140 and aligned in parallel with the conductors 74 of the compliant body 70. The ribs 144 are of a size so that they press the compliant body 70 against the microphone 124 to form an airtight seal over the terminals 50 and maintain secure electrical contact between the conductors 74 and both terminals 50 and corresponding conductors on the circuit board. The upper surface of the housing 100 is provided with a linear raised shoulder 150 vertically aligned with the cavity 140. When the device is assembled, the rib 150 is pressed against the casing to exert a downward force against the housing 100 which is conveyed to the compliant body 70 to assist in maintaining it securely against the terminals 50 and the corresponding conductors on the circuit board.

To assemble the device, the microphone 124 and the compliant body 70 are inserted into their respective cavities in the housing 100. Then the housing with the microphone 124 and compliant body 70 in place, is mounted to the circuit board by aligning the legs 110 with corresponding holes in the circuit board, and drawing the legs 110 through the holes until the bottom surface 104 of the housing abuts the circuit board, thus to press the microphone 124 and compliant body 70 thereagainst. The diameters of the legs 110 are selected to be slightly larger than the diameters of the corresponding holes in the circuit board, so that once the legs have been drawn through the holes and allowed to relax, they expand in size to grip to the holes securely.

In addition to the advantages described above, the present invention includes the following further advantages and/or merits. It saves manufacturing cost by eliminating labor intensive wiring and soldering required by conventional assembly methods. The device of the present invention can be assembled by simply inserting the compliant body into the cavity in the housing without further efforts and is therefore cost-effective. The electrical connection system of the invention also provides substantial flexibility in the design of the assembly. Patterns and arrangements of electrical terminals and connections may be varied. Moreover, by pressing of the compliant body against the contacts, its compliant material conforms to the exterior of the component to prevent deteriorating of metal contacts and terminals due to contact with the air. As mentioned before, the present invention is useful in maintaining electrical contact despite vibrations or impacts. For example, instead of the microphone, a battery or other electrical components may be securely connected to the circuit board or other components utilizing the principles and concepts of the invention. It is also noted that the invention is particularly useful for securely connecting of a microphone to other electrical components as described above.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An audience data gathering device, comprising:
an enclosure having a sound port;
a microphone mounted in the enclosure and communicating acoustically with an exterior of the enclosure through the sound port to receive acoustic energy therefrom and serving to transduce the acoustic energy to electrical data;
a processor mounted in the enclosure and having an input;
a circuit board mounted in the enclosure and having an electrical conductor thereon coupled with the input of the processor;
the microphone having an electrical output terminal thereon;
a compliant body having a circumferential surface pressing against the electrical output terminal of the microphone and the circuit board; and
an electrical conductor extending on the circumferential surface of the compliant body and pressed thereby against and in electrical contact with the output terminal of the microphone and the electrical conductor of the circuit board.

2. The device of claim 1, wherein the electrical conductor extending on the compliant body defines a ring-like configuration encircling the circumferential surface of the compliant body.

3. The device of claim 1, wherein the electrical conductor extending on the compliant body comprises metal.

4. The device of claim 1, wherein the electrical conductor is arranged in a groove provided on the circumferential surface of the compliant body.

5. The device of claim 1, wherein the compliant body includes more than one electrical conductor extending on the compliant body.

6. The device of claim 5, wherein the electrical conductors are spaced apart in parallel with each other.

7. The device of claim 6, wherein the electrical output terminal of the microphone includes more than one electrical output contact.

8. The device of claim 7, wherein the compliant body has a generally cylindrical shape.

9. The device of claim 1, wherein the compliant body comprises silicone rubber.

10. The device of claim 1, wherein the enclosure comprises a housing for enclosing and receiving the microphone and the compliant body therein.

11. The device of claim 10, wherein the housing comprises a wedge-shaped portion pressing the compliant body against the microphone and the circuit board.

12. The device of claim 10, wherein the housing comprises at least one rib on an inner surface thereof pressing the compliant body against the microphone and the circuit board.

13. The device of claim 10, wherein the housing comprises compliant material disposed adjacent the microphone for reducing generation of noise by the microphone resulting from vibrations or impacts of the device.

14. An assembly for making an electrically conductive connection between two components, comprising:
a first electrical component having a first electrical terminal on an exterior surface thereof;
a second electrical component having a second electrical terminal on an exterior surface thereof;
a compliant body having a curved circumferential surface pressing against the exterior surfaces of the first electrical component and the second electrical component; and
an electrical conductor extending on the curved circumferential surface of the compliant body and pressed against the first electrical terminal and the second electrical terminal between the compliant body and the first and second electrical components, such that the first and second electrical terminals of the first and second electrical components are electrically connected by the electrical conductor.

15. The assembly of claim 14, wherein the first electrical component comprises a microphone.

16. The assembly of claim 14, wherein the compliant body has a generally cylindrical shape.

17. The assembly of claim 16, wherein the electrical conductor extends about the circumferential surface of the compliant body.

18. The assembly of claim 16, wherein the compliant body has a circular cross section.

19. The assembly of claim 16 wherein the compliant body has an oval cross-section.

20. The assembly of claim 14, comprising a housing, wherein the first component and the compliant body are positioned within the housing and wherein the housing presses the compliant body against the first component.

21. The assembly of claim 20, wherein the second component comprises a circuit board to which the housing is affixed and the housing presses the compliant body against the circuit board.
